(19) United States
(12) Patent Application Publication
(10) Pub. No.: US 2007/0244888 A1
(43) Pub. Date: Oct. 18, 2007

(54) AFFINITY ATTRIBUTES FOR PRODUCT ASSESSMENT

(75) Inventors: Robert S. Chea, San Mateo, CA (US); Andrew Y. Chen, San Francisco, CA (US)

Correspondence Address: Trellis Intellectual Property Law Group, PC, 1900 EMBARCADERO ROAD, SUITE 109, PALO ALTO, CA, 94303, US

(73) Assignee: POWERREVIEWS, INC., Millbrae, CA (US)

(21) Appl. No.: 11/692,124

(22) Filed: Mar. 27, 2007

Related U.S. Application Data
(63) Continuation-in-part of application No. 11/474,095, filed on Jun. 22, 2006.
(60) Provisional application No. 60/723,369, filed on Oct. 3, 2005.

(51) Int. Cl. G06F 17/30

(52) U.S. Cl. 707/6

(57) ABSTRACT

A system allows users to create keywords to describe an item such as a product or service. The keywords can be used by additional users, such as shoppers at websites on the Internet, to obtain information about a product or service for purposes of making a purchase. Affinity attributes are used to help define keywords that relate to an experience level of a user of a product or service; and that relate to how a product or service is used.

### CLAIM OF PRIORITY AND REFERENCE TO RELATED APPLICATIONS

This application is a continuation-in-part application from U.S. patent application Ser. No. 11/474,095 filed Jun. 22, 2006 entitled “System for Obtaining Product Reviews Using Selections Created by User Base” which, in turn, claims priority from U.S. Provisional Patent Application Ser. No. 60/723,369 filed on Oct. 3, 2005 entitled “TAGBACK VOTING INTERFACE, A METHOD FOR COLLECTING USER FEEDBACK THAT AUTOMATICALLY UPDATES VOTING OPTIONS BASED ON THE VOTE OR FREEFORM TEXT ENTRY OF PREVIOUS USERS” which is hereby incorporated by reference as if set forth in full in this application for all purposes.

This application is related to co-pending U.S. patent application Ser. No. 11/474,097 filed on Jun. 22, 2006 entitled “System for Dynamic Product Summary based on Consumer-Contributed Keywords” which is hereby incorporated by reference as if set forth in full in this application for all purposes.

### BACKGROUND OF THE INVENTION

This invention relates in general to obtaining information via digital processing systems and more specifically to a system for providing product or service specific advice and recommendations to an online shopper by using.

Consumer opinions are useful to manufacturers, sellers, marketers and other participants in a commercial supply chain so that the participants may more effectively create, advertise and sell products and services. Opinions can also be useful in any other areas such as opinion polls for government candidates, popularity of proposed laws; predicting financial securities, obtaining knowledge of social issues, etc.

Digital communication networks, such as the Internet, and popular presentation formats such as Hyper-Text Markup Language (HTML) as used on the World Wide Web (WWW) have provided many benefits for gathering opinions of consumers. The Internet allows efficient gathering of consumer opinions in the form of, for example, product reviews. Users of computer systems are presented with a page that allows a user to type in a product review. The review can be read by an administrator and used to compile statistical information about the product.

A more efficient approach is to allow a user to give a rating value to the product in the review either in place of, or in addition to, a typed explanation type of review. The product review and rating can then be viewed by other users for additional comment and further rating of the product. Many reviews can be combined statistically to obtain an overall rating of the product. Some types of rating systems can be based on a numeric value, five-star system, etc.

A more flexible rating approach is to use tags such as a word or group of words (e.g. a phrase) to describe a product in a review. If the same words are used in many reviews then those tags can be identified as important in describing a product. However, the tags are typically defined by an administrator and are then presented to a user for use in the user's review. A user may select a tag from a list of tags. In this approach it can be difficult to track ratings where the meaning of a tag, or its meaning with respect to a product, changes over time. For example, a product may become less favored as time goes by and newer, better products come into the market. Tags that were compiled at a time before the competing product's arrival may not be as relevant as words used to describe the product after introduction of the competing product. For example, a tag might describe a product as “screen scratches easily”. When this manufacturing defect is fixed the tag may no longer be accurate so offering the tag as an option to the user would no longer be relevant or useful.

Users can also be allowed to enter or create tags in a review (see, e.g., www.epinions.com). The tags can then be compiled and statistically tracked to arrive at a summary or other indication of overall sentiment about the product. One drawback with this approach is that it relies on consistent user use of tags. Such consistency is usually not realized due to the subjective and complex nature of language. For example, if one user uses “strongest” as a tag and another user uses “sturdiest” or “much better than this other weaker product” as a tag the system may not detect that both users have said essentially the same thing about a product.

With the prior art approach, many users may intend the same meaning but may use different tags to express the meaning. Thus, correlations among reviews might be missed and an overall rating may be inaccurate.

### BRIEF DESCRIPTION OF THE DRAWINGS

FIG. 1 shows an exemplary process for obtaining reviews;

FIG. 2 is a graphic representation of basic steps to obtain reviews from users;

FIG. 3 shows more details of a web page for requesting a user review according to an embodiment of the invention;

FIG. 4 illustrates a computer system suitable for use with the present invention;

FIG. 5 shows basic subsystems in the computer system of FIG. 4;

FIG. 6 is a generalized diagram of a typical computer network suitable for use with the present invention;

FIG. 7 shows an example of a product review survey interface using affinity attributes;

FIG. 8 shows a first portion of a purchaser interface for entering affinity attribute information for use in obtaining product reviews;

FIG. 9A shows a second portion of a purchaser interface for entering affinity attribute information for use in obtaining product reviews;

FIG. 9B shows a third portion of a purchaser interface for entering affinity attribute information for use in obtaining product reviews; and

FIG. 9C shows a fourth portion of a purchaser interface for entering affinity attribute information for use in obtaining product reviews.

### DETAILED DESCRIPTION OF THE INVENTION

Typically, sellers such as retailers and service providers are interested in obtaining reviews from customers, potential customers, product-savvy people, or others (i.e., users) so that the seller can understand what goods might sell better, how to improve a service, etc. These reviews also help other users by describing the benefits and drawbacks of products and services. Manufacturers, marketers, advertisers and other entities are also often interested in obtaining reviews for purposes of increasing sales, targeting customers, improving products, and for other reasons. Those interested in obtaining reviews are referred to here as “customer companies” of a “facilitating company.” The facilitating company assists in obtaining reviews for customer companies. Note that although the invention may be discussed in terms of customer companies and facilitating companies this is only for purposes of illustration of a preferred embodiment. In general, any functions, steps, device operations or other aspects of the invention may be created or performed under the management, influence or control of any one or more entities, in one or more places and at one or more points in time. Details of a preferred embodiment regarding roles played by specific entities are described in the co-pending patent application referenced above.

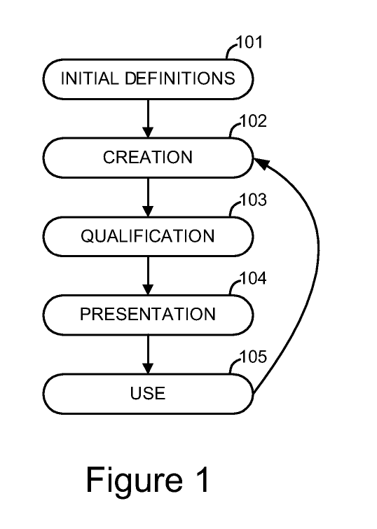

An exemplary process for obtaining reviews is shown in the flowchart of FIG. 1. The approach is divided into five phases, as (1) an Initial Definitions Phase (2) a keyword Creation Phase (3) a Qualification Phase, (4) a Presentation Phase and (5) a Use Phase. Note that this is a broad illustration of possible phases for purposes of discussion. Other characterizations of a review system can omit or add phases. Phases might be combined with each other. Details of the phases can vary.

In Initial Definitions Phase 101 of FIG. 1a human administrator at the facilitating company creates an initial list of keywords and a general template or format to allow a user to create a review of an item. In a preferred embodiment, the reviews are obtained by presenting a web page to a first user. The web page includes the initial list of keywords and overall presentation created by the administrator. Other approaches can include automated formation of the initial list and the automated generation of content for a review page. In general, unless otherwise stated, one or the other, or both, of manual or automated steps can be used for functions described herein. A combination of manual and automated operations can be used, as desired.

In Creation Phase 102 the first user can create additional keywords. One way to do this is to allow the user to type in keyword candidates as, for example, from a computer keyboard. The first user can include the new keywords as part of their review. Other embodiments allow new keywords to be detected without explicit designation by the first user. For example, text that the first user enters as part of a plain-language review can be parsed to identify keyword candidates.

In Qualification Phase 103, the new keyword candidates are subjected to one or more tests that uses one or more criteria. If the new keyword does not pass the test(s) it will not be presented to subsequent users for optional use in additional reviews. A test can include, for example, review by a human moderator or automated statistical checking to determine if the keyword candidate is also being suggested by other users or occurs in other reviews.

In Presentation Phase 104 the qualified new keyword is presented to a subsequent (e.g., “second”) user for use in a subsequent review. In a simple case the presentation can include the new keyword added to the existing list of keywords (e.g., the initial list of keywords created by the administrator).

In Use Phase 105 a second user has selected the new keyword for inclusion in the second user's subsequent review. The fact that the new keyword has been used in the subsequent review can then be tabulated, summarized, compiled or otherwise used to generate ratings or statistics. Other characteristics of the first and subsequent reviews can also be tracked and correlated in order to generate useful statistics such as overall ratings. These overall ratings can be used for reporting to customers or others.

The subsequent review might add more new keywords and can then be subjected back to the Creation Phase for processing the new keywords in a manner similar to the above for the first user's new keyword. Users may be allowed to perform other operations on keywords or keyword lists or sets such as adding more new keywords, deleting keywords, rating keyword effectiveness, rating a keyword creator's effectiveness, etc. Such modifications can be done by user consensus or “vote” such as where the addition or deletion of a keyword is according to highest number of votes, a threshold number of votes, etc.

As mentioned above, other variations are possible. For example, where there are two entities involved in obtaining a user review, such as a customer company that maintains a website for selling a product and a facilitating company that manages a review process that is tied in to the customer company's website, both the customer and facilitator may be involved in one or more of the phases. The customer and/or facilitator can provide automated content or manual design into the initial keyword list and definitions used to present a web page to a first user. Given the many possibilities of presenting information on the Internet, a web page (or other output format) can include content from one or both of the customer or facilitator. Other entities can be involved such as a web hosting company, catalog management company, server farm operator, etc. Similarly, other phases discussed above can be achieved by using different entities and other suitable approaches.

Any number of user's may act as “first” users who create keywords. Any number of users may also act as “second” users to select, rate or otherwise use or modify the keywords. The acts of creating, using and modifying keywords can be performed by one or more users at a same user session (e.g., within the same web page or web site, during a login period, etc.) or at different sessions, places and/or times.

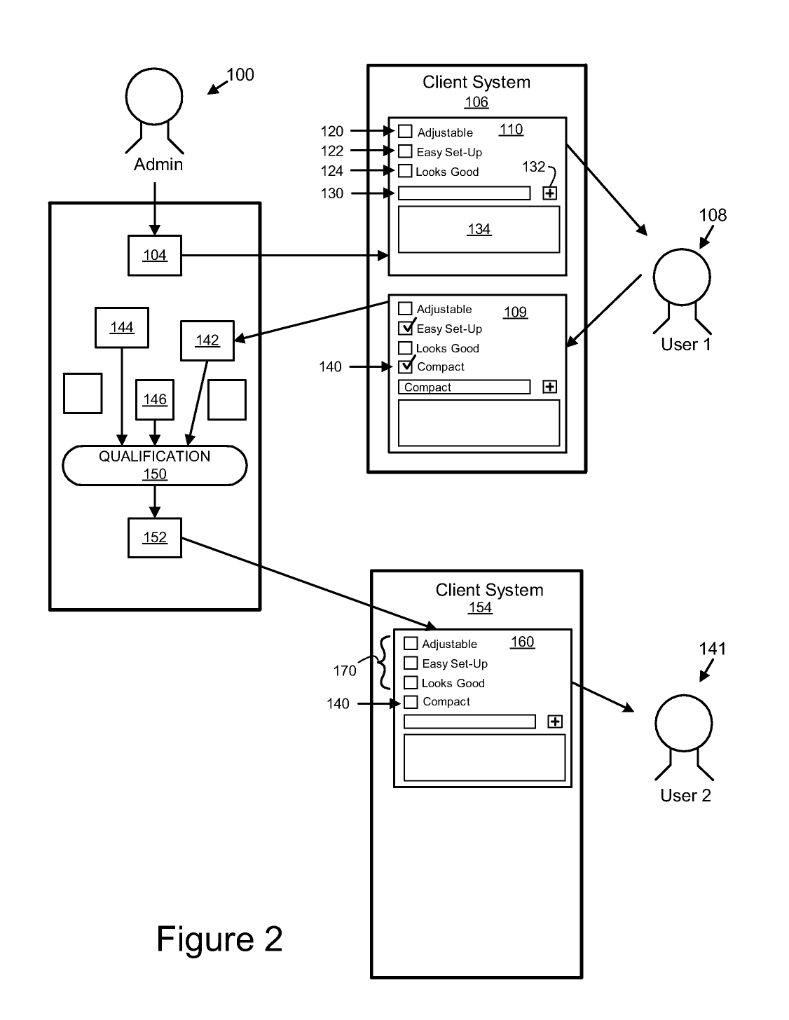

FIG. 2 is a graphic representation of exemplary basic steps to obtain reviews from users where the reviews include keywords created at least in part by the users.

In FIG. 2, Admin 100 creates web page definition 104 that includes an initial list of keywords. Web page definition is accessed by client system 106 for viewing by User1 at 108. The web page definition is used to generate web page display 110 that includes three keywords from the initial list that are displayed as selectable options at 120, 122 and 124. Also included in the web page display are keyword creation text box 130 and keyword include button 132. Review text box 134 is also provided for the user to type in a general plain-language type of review for posting to a compilation of reviews for later reading by other users.

Assuming User1 enters a keyword into keyword creation text box 130 and then selects include button 132 the web page is updated and displayed as web page 109 to show the new keyword now included in the list at 140. The new list definition including the new keyword is sent back to the server and stored as definition 142. Similarly, other definitions that include user-defined keywords are shown stored in the server as 144 and 146. Any suitable approach and format to storing data is possible. For example, HTML, XML, plain-text, database, binary or other forms of storing definitions can be used. Additional information can be included in the web page and the web page display. Other features of the web page can be modified, as desired, including the input and selection methods; or the output display design or arrangement.

In a preferred embodiment the user receives the definition transfer via a network such as the Internet. The user views the web page by using a digital processing system that executes a browser program such as Mozilla's Firefox™, Netscape's Navigator™, Microsoft's Internet Explorer™, etc. The digital processing system can operate on any platform such as a desktop or laptop computer system, smaller portable system such as a Personal Digital Assistant (PDA), email messaging system, handheld computer, tablet computer, cell phone, audio player, etc. In other embodiments any type of communication link (e.g., wired, wireless, optical, etc.), network (e.g., local-area network (LAN), wide-area network, etc.) or communication approach can be used.

Qualification process 150 scans the new definitions and attempts to approve the new keyword 140 and any other keywords in the definition database (e.g., definitions 144 and 146). One way to achieve approval is if a predetermined number or percentage of new keywords is deemed to appear within new definitions within a time interval. If so, the new definition becomes an approved definition and can be provided to subsequent users for additional reviews as shown by the instance of definition 152.

A subsequent user, such as User2 at 141 is presented with web page 160 that is created from definition 152 on client system 154. Web page 160 includes new keyword 140 which can be selected in the same manner as other keywords at 170 which can include keywords from the initial list, other user-created keywords, or other information. The keywords that are presented can vary according to user, location, time, etc. For example, there may be different keywords presented based on product categories, such as tennis racquets vs. bicycles vs. golf clubs, etc.

Naturally, any number and type of users, reviews, definitions, keywords, client systems, etc., can be used. It is anticipated that larger numbers of users and reviews will generate more valid keywords. It may be desirable to limit the number of keywords in a list of keywords that are presented to a user since many users do not wish to spend a lot of time composing reviews and selecting keywords from among many keywords can be time-consuming. A link can be provided to a larger list of keywords to provide more ideas to users.

Known unique keywords can be used for unambiguously matching reviews. This is different from a review approach where free-form plain-language reviews are used. In such free-form type of reviews it can be difficult, inefficient or inaccurate to correlate the reviews since different users may state the same type of praise or complaint using different sentences and words. For example, one user may write that “the couch was not firm enough” and another may write “the couch was too soft.” These two reviews may not be detected by an automated system as essentially stating the same complaint. However, if there is a keyword selection such as “too soft” that can be selected or not, it is likely that both of the reviewers would have chosen the “too soft” selection, thus providing an easy correlation.

By allowing the users themselves to affect the list of selectable keywords the review process is able to tap into the actual consumers' knowledge, jargon and current market situation. For example, several users may start to compare a product to a new competitor's product that just came out. In this example, the users would create a new keyword such as “not as fast as Brand X”. This keyword option can appear in the review input pages very soon after consumers form a comparison belief about two products. For example, a system according to the present invention might update keywords in hours or minutes. The updating can be automated to prevent long time lags between updates, or the failure to update at all, as may be seen in other approaches.

Other variations are possible. The user base can be allowed to remove keywords by “voting” such as by clicking on a “remove” button or unchecking the checkbox next to a keyword's listing. This may be useful where the keyword is not relevant anymore due to changes over time or place. For example, a competitor's product may be taken off the market or recalled. Or some keyword options may not be relevant in different countries or places (e.g., “does not work on 220 volt power”). The definitions such as 152 can be served to client computers based on geographic location. Keywords can be rated by users to indicate perceived effectiveness or popularity. For example, a keyword's effectiveness in conveying a product feature or defect can be rated and keywords with collective low ratings can be automatically eliminated.

The actions of weighting the effectiveness of keywords to promote their use in keyword lists or to remove keywords from the lists can also be done automatically. For example, if keywords are selected often by users for use in their reviews then those keywords can be weighted heavily and used often or all the time in the list of keywords presented to a user. The weighting can be over time intervals, by geographic region, product category, etc. Similarly, keywords that are not selected often or at all can be removed from the list.

The keyword can be translated into different languages depending on the location of the target client. Synonyms can be substituted for different words or phrases having essentially the same meaning so that the keywords are “normalized” for different language uses.

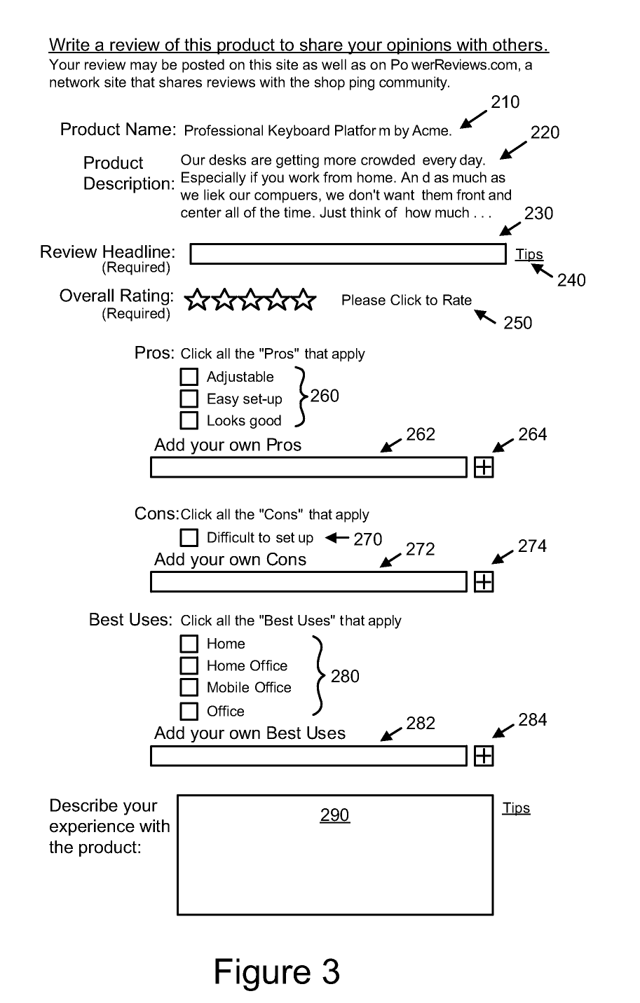

FIG. 3 shows more details of a web page for requesting a user review according to an embodiment of the invention. Many variations of a web page for presenting and requesting keywords are possible.

In FIG. 3, a product name for review is listed at 210. In this case the product is “Professional Keyboard Platform” and the manufacturer or provider is “Acme.” A product description appears at 220. The product description can be prepared by an administrator or other interested party. It is also possible to include a user description, if desired.

A user may enter a headline for a new review at 230. A “tips” link at 240, if clicked, provides suggestions on a format for a good headline. For example, the user can be encouraged to use a short, concise, witty and descriptive headline that indicates by itself how well the product was liked or disliked.

An overall rating can be obtained from a user at 250. The overall rating can be used to roughly characterize the review into “pro” or “con” in a later statistical analysis. The overall rating may also be useful to weight new keywords that the user provides. For example, a “pro” keyword submitted with a 5 star rating might be given more weight in later analysis than the same “pro” keyword with a 3 star weighting. The ratings can also be used to detect and disqualify keywords submitted by users who continually criticize or praise products, product lines, products from specific manufacturers, etc. Note that the rating feature is optional and need not be included in all embodiments. In general, features of the invention may be used independently of one another in different embodiments.

A “pro” keyword that is in favor of the product can be selected at 260, where already-created keywords “Adjustable,” “Easy set-up,” and “Looks good” are shown. The user can enter a new “pro” keyword by typing text at 262 and pressing the include button at 264. Multiple keywords can be selected and/or defined.

Similarly “con” keywords can be selected and defined in the next section using con selection list 270, text box 272 and include button 274. Yet another category of keywords is “Best Uses” at 280, using text box 282 and include button 284. Note that any type of category for keywords can be used. In other embodiments it may be desirable to allow users to create new categories of keywords in addition to the keywords, themselves.

A general free-form text review can be entered at text box 290. Although FIG. 3 shows certain inputs such as “Review Headline,” “Overall Rating” and “Describe your experience with product” as being required, such requirements can be different in other embodiments, as desired. In general, any number, type, arrangement or manner of presenting or requesting keywords and review parameters is possible.

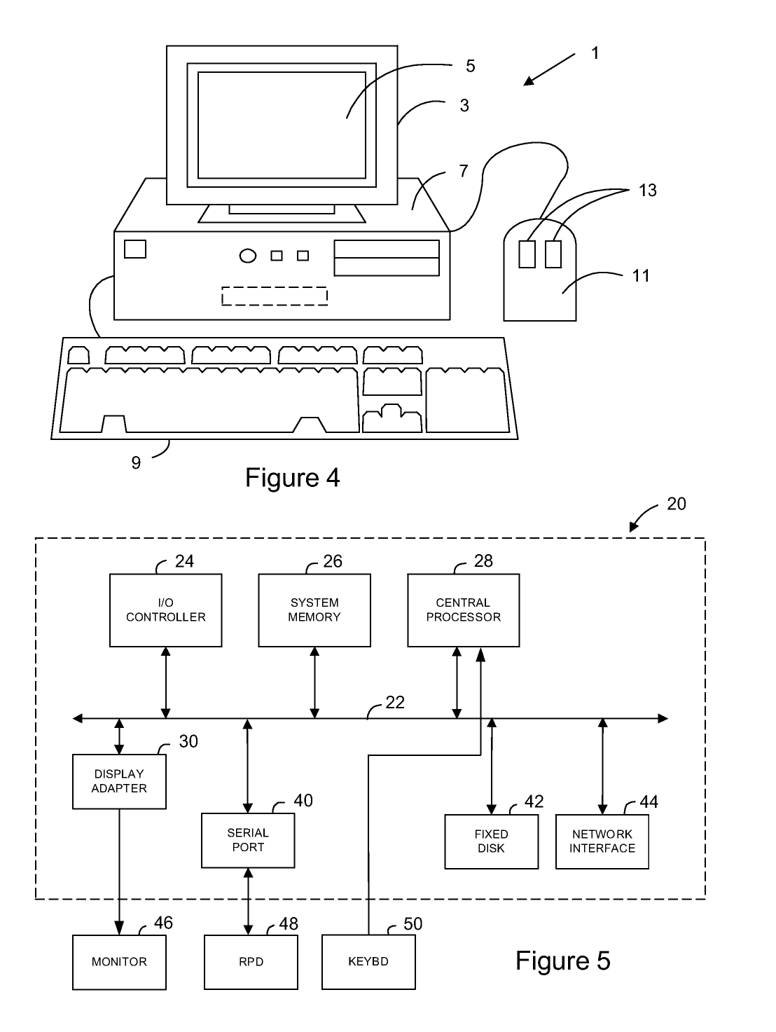

FIGS. 4, 5 and 6 illustrate basic hardware components suitable for practicing the present invention.

FIG. 4 is an illustration of computer system 1 including display 3 having display screen 5. Cabinet 7 houses standard computer components (not shown) such as a disk drive, CDROM drive, display adapter, network card, random access memory (RAM), central processing unit (CPU), and other components, subsystems and devices. User input devices such as mouse 11 having buttons 13, and keyboard 9 are shown. Other user input devices such as a trackball, touch-screen, digitizing tablet, etc. can be used. In general, the computer system is illustrative of but one type of computer system, such as a desktop computer, suitable for use with the present invention. Computers can be configured with many different hardware components and can be made in many dimensions and styles (e.g., laptop, palmtop, pentop, server, workstation, mainframe). Any hardware platform suitable for performing the processing described herein is suitable for use with the present invention.

FIG. 5 illustrates subsystems that might typically be found in a computer such as the computer of FIG. 4.

In FIG. 5, subsystems within box 20 are directly interfaced to internal bus 22. Such subsystems typically are contained within the computer system such as within cabinet 7 of FIG. 4. Subsystems include input/output (I/O) controller 24, System Memory (or random access memory “RAM”) 26, central processing unit CPU 28, Display Adapter 30, Serial Port 40, Fixed Disk 42, Network Interface Adapter 44. The use of bus 22 allows each of the subsystems to transfer data among subsystems and, most importantly, with the CPU. External devices can communicate with the CPU or other subsystems via bus 22 by interfacing with a subsystem on the bus. Thus, Monitor 46 connects with Display Adapter 30, a relative pointing device (e.g. a mouse) connects through Serial Port 40. Some devices such as Keyboard 50 can communicate with the CPU by direct means without using the main data bus as, for example, via an interrupt controller and associated registers.

As with the external physical configuration shown in FIG. 4, many subsystem configurations are possible. FIG. 5 is illustrative of but one suitable configuration. Subsystems, components or devices other than those shown in FIG. 5 can be added. A suitable computer system can be achieved without using all of the subsystems shown in FIG. 5. For example, a standalone computer need not be coupled to a network so Network Interface 44 would not be required. Other subsystems such as a CDROM drive, graphics accelerator, etc. can be included in the configuration without affecting the performance of the system of the present invention.

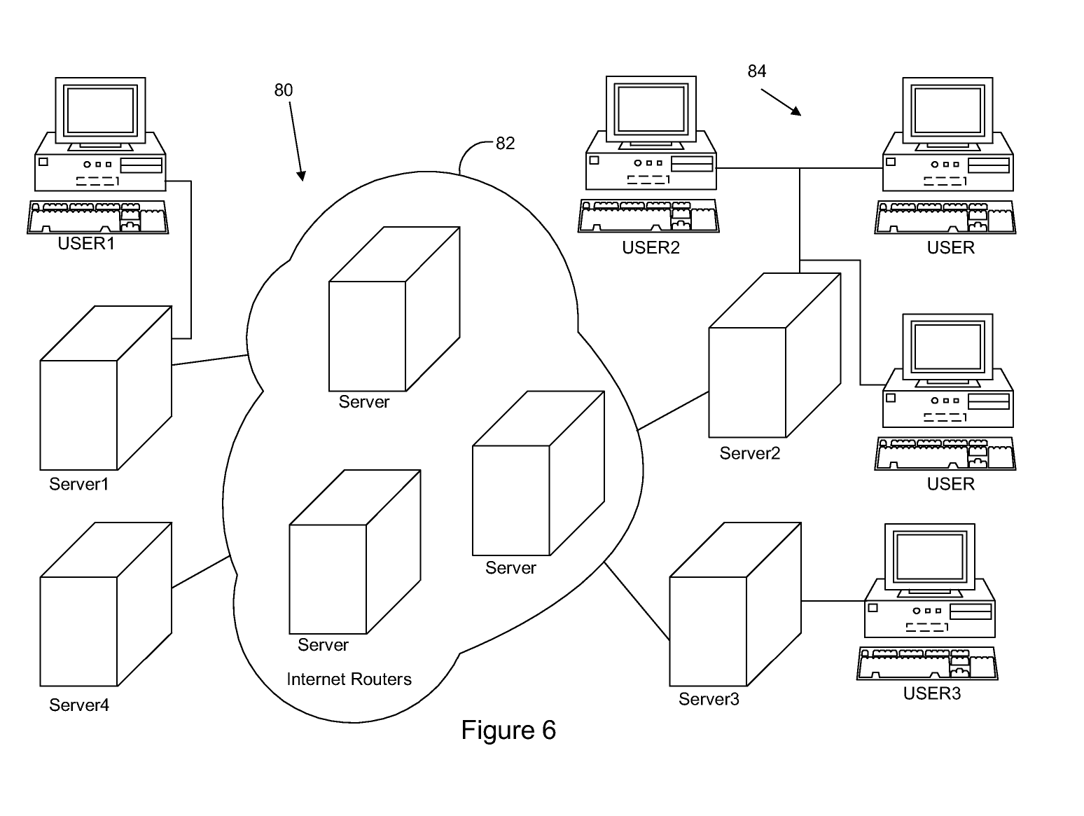

FIG. 6 is a generalized diagram of a typical network.

In FIG. 6, network system 80 includes several local networks coupled to the Internet. Although specific network protocols, physical layers, topologies, and other network properties are presented herein, the present invention is suitable for use with any network.

In FIG. 6, computer USER1 is connected to Server1. This connection can be by a network such as Ethernet, Asynchronous Transfer Mode, IEEE standard 1553 bus, modem connection, Universal Serial Bus, etc. The communication link need not be a wire but can be infrared, radio wave transmission, etc. Server1 is coupled to the Internet. The Internet is shown symbolically as a collection of server routers 82. Note that the use of the Internet for distribution or communication of information is not strictly necessary to practice the present invention but is merely used to illustrate a preferred embodiment, below. Further, the use of server computers and the designation of server and client machines is not crucial to an implementation of the present invention. USER1 Computer can be connected directly to the Internet. Server1's connection to the Internet is typically by a relatively high bandwidth transmission medium such as a T1 or T3 line.

Similarly, other computers at 84 are shown utilizing a local network at a different location from USER1 Computer. The computers at 84 are coupled to the Internet via Server2. USER3 and Server3 represent yet a third installation.

Affinity Attributes

One type of keyword that is useful is referred to as an “affinity attribute.” An affinity attribute describes the similarity between people or things. One effective way to describe products, services or other items to a consumer wishing to make a purchasing decision is to obtain information for the consumer from others who are using the product in a way that the consumer intends. A preferred embodiment of the invention focuses on (1) the level of experience of a user of the item and (2) on the manner in which the item will be used. Values for these “usage factors” can be obtained by asking questions of a reviewer or consumer in the form of “who am I” to obtain a user-type and “how will I use it” to obtain one or more uses. Note that many other affinity attributes, factors and ways to obtain or establish the values for the factors are possible.

For example, a consumer looking to purchase skis can be directed to valuable information about skis if the consumer states that they are an advanced skier and like to ski in powder. Thus, the user-type is “advanced” and the uses include “powder”. These values are then used as keywords in obtaining item information in the manner described, above.

In a preferred embodiment, an item profile is created that includes usage factors such as user-type and uses. An item profile can include multiple uses of an item by prior users of the item with differing experience levels (i.e., user-types). This aggregated data can be used for recommendations to other consumers with similar intended uses and levels of experience. The relevance and usefulness of such recommendations is higher, because they incorporate actual item usage patterns by real customers.

A review survey form is used to obtain user-type and uses information from a reviewer. An admin can define the initial set of keywords in the user-type and uses categories and a reviewer can use the initial keywords or can create additional keywords in a web page such as web page display 106 of FIG. 2. One embodiment requests the question types shown in Table I from reviewers.

TABLE I
(i) a satisfaction index in the form of an item rating or explicit
recommendation of an item;
(ii) a description or selection of “best uses” for an item;
(iii) a description or selection of the user's experience level regarding the
item; and
(iv) a description or selection of the length of time using a item.

In Table I, questions (ii) and (iii) from the above are designed to obtain values for the usage factors user-type and users, respectively. Note that in other embodiments different questions may be asked and some of the questions in Table I may be omitted while other questions can be added or substituted.

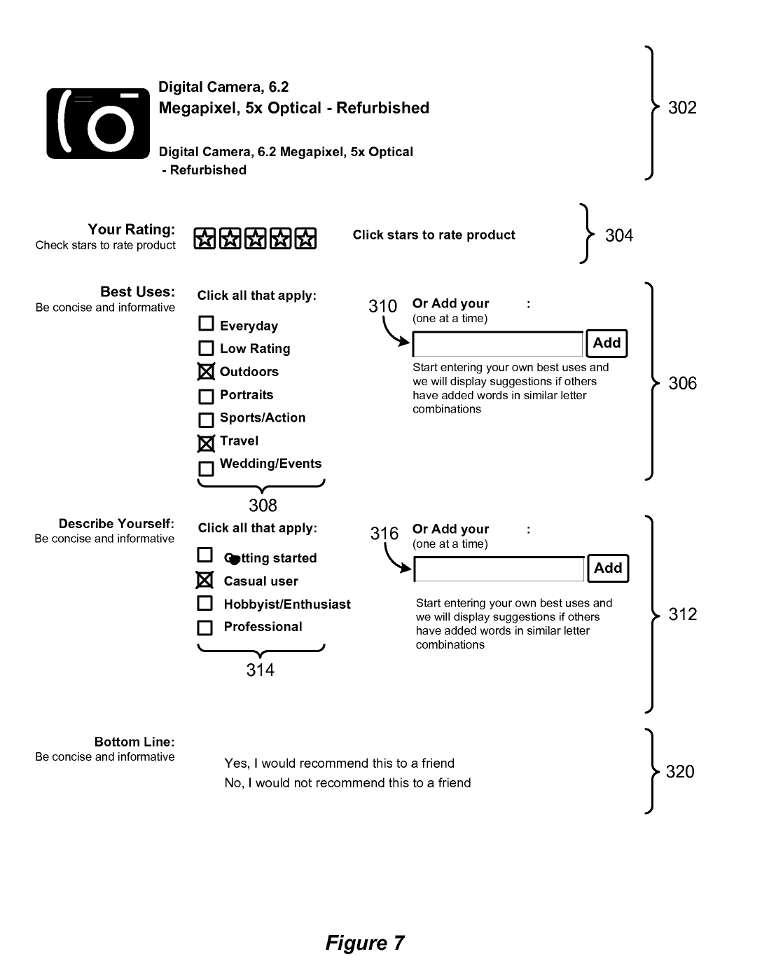

FIG. 7 shows an example of a item review survey interface. The item for which a review is being obtained is depicted at 302. The reviewer is asked to select the number of stars from 1-5 at 304 in order to provide a basic rating for this item. At 306 a “best uses” question is asked to obtain use information. The reviewer can select from one of the existing keywords at 308 (one or more of which could have been defined by other users) or can create a new keyword for the “uses” attribute at 310. This attribute establishes how the reviewer uses the item. In this case the reviewer has selected that they use the digital camera for “outdoors” and “travel” photography.

At 312 the survey asks the reviewer to describe themselves. The reviewer can select from pre-existing keywords at 314 or can create a new keyword at 316. In this case the reviewer has selected “Casual user” as the level of experience or user-type.

Finally, at 320, the reviewer can provide a “yes” or “no” answer to whether, overall, they would recommend purchasing the item or not. The length of time that the reviewer had been using the item is not included as a question in this example.

Many other selections, number and arrangements of questions or input possibilities are possible. For example, although the satisfaction index often appears in the form of an item numeric rating (e.g., a 5-star rating), or an explicit recommendation (e.g., “Yes, I would recommend this item”), other ways to indicate a single or simple value of satisfaction can be used. The other data around best uses, level of experience, length of ownership, etc. may be text or numeric based. Questions may appear in the form of free-form text boxes or selection buttons, or any combination thereof With free-form text-based input it may be necessary to correlate the data to determine the level of agreement among multiple reviewers. While it is possible to use computer algorithms to determine agreement based on user-inputted text, a preferred embodiment uses the user-defined keyword approach described herein to allow selection and creation of affinity attributes as keywords.

Descriptions of levels of experience and best uses will typically vary by item category. For instance, in a category of cycling, example experience level selections may include:
Casual/recreational user
Avid cyclist
Triathlete
Professional cyclist
   Additionally, sample best uses for Road Bicycle Tires may include:
Slippery conditions
Uneven terrain
Hilly terrain
Commuting
Sprinting/Racing
Training

As review data is obtained it is aggregated into item profiles. By aggregating reviewer responses to satisfaction, affinity, and usage questions, it is possible to build a item profile that encompasses general usage patterns and user types. For instance, in the category of digital cameras, based on customer reviews, camera A may be highly recommended by professionals who use camera A for wedding photos, while camera B may be highly recommended by casual customers who use camera B for travel-related photos. Thus, the corresponding item profiles could indicate that camera A is recommended for professional users, for wedding photography; while camera B is recommended for casual users, for travel photography.

Over time, as more customers contribute their reviews about these cameras describing their satisfaction, usage patterns and levels of experience in photography, these camera profiles may change or may be reinforced.

Items with these item profiles may then be grouped into varying assortments recommended to certain types of users based on the users' answers to affinity attribute questions. An assortment may consist of one or more items. For instance, some example assortments may include (1) cameras recommended by professional users for wedding photography; (2) cameras recommended by professionals; and (3) cameras recommended for wedding photography.

When users are searching for items, they generally look for items that are best suited for them and their intended usage. For instance, a professional photographer would probably be most interested in cameras that other professional photographers recommend. Additionally, a professional wedding photographer may also further narrow the assortment of cameras recommended by other professionals to only those cameras that were also recommended for weddings. In this manner, a user's affinity segmentation, which consists of one or more criteria describing usage pattern and level of experience, may be used to find the most recommended and relevant cameras for their needs. In other words, a professional wedding photographer can find items recommended by other professional wedding photographers.

This technique is similarly applicable to gift shopping. For instance, a professional photographer shopping for a camera for someone who is a casual camera user may narrow and find only those cameras recommended by other casual users. Thus, the affinity attributes need not be specific to a consumer trying to obtain item information but can be targeted to the end user or beneficiary of the purchase.

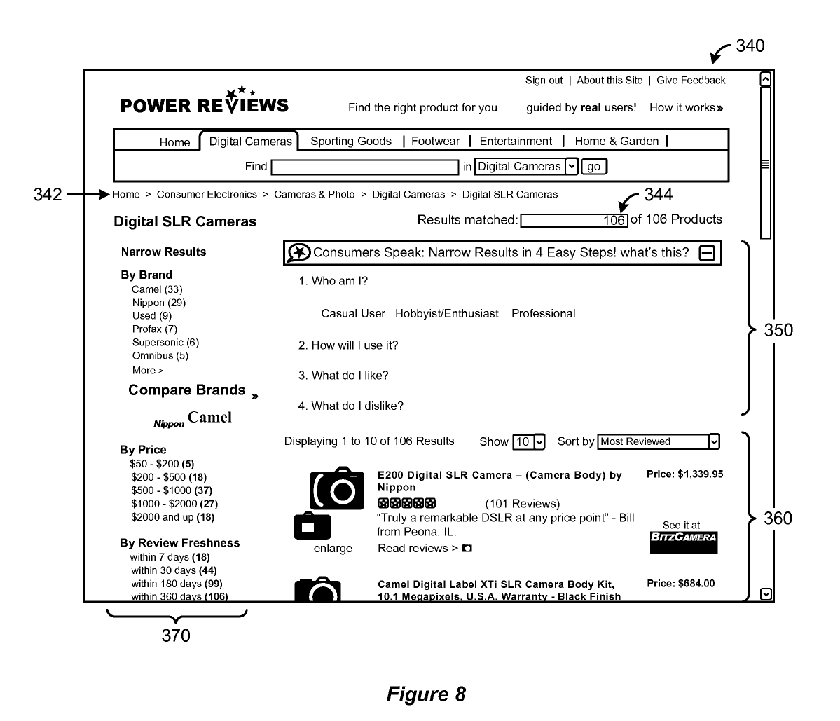

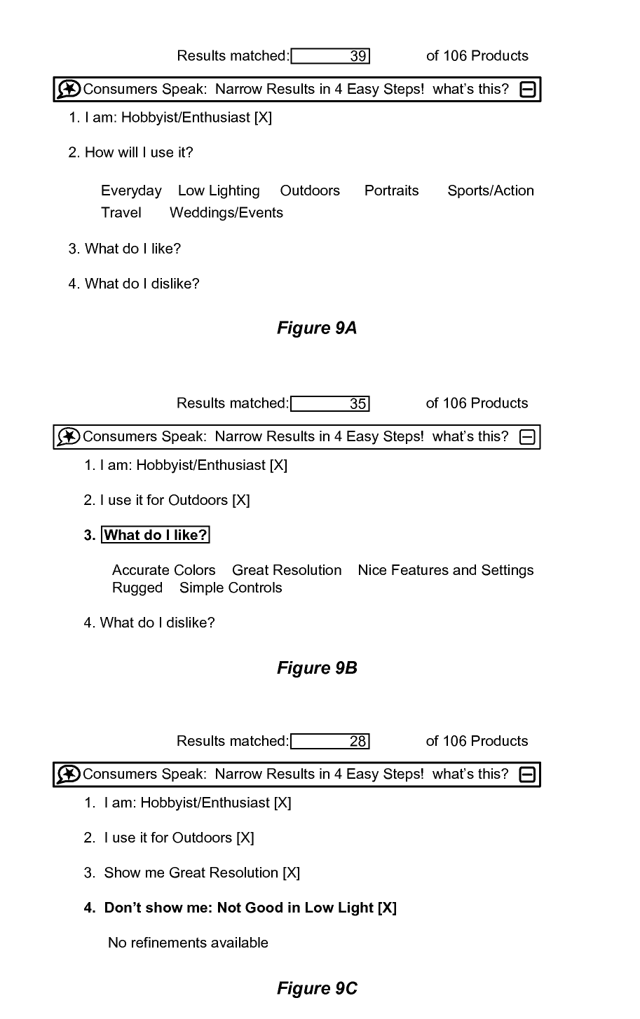

FIGS. 8 and 9A-C illustrate portions of a purchaser interface for entering in affinity attribute information to obtain item recommendations.

In FIG. 8, portion of web browser window 340 displays a top part of a page for a shopping interface. Path 342 near the top part of the page shows the hierarchy of categories within which a shopper has navigated to get to the current item category of “Digital SLR Cameras.” The number of item models in this category is shown at 344 as 106 products total. Since the item category has not yet been filtered the display indicates that there are “106 of 106 products” being displayed. Details of each item is displayed toward the bottom of the page at 360. Additional item information can be viewed by scrolling down or by moving to other pages, as is known in the art. Items can be filtered by brand, price, recency of reviews, etc. as shown at 370.

Area 350 includes the input interface for selection of affinity attributes. These are obtained by asking 4 questions as “Who am I,” “How will I use it,” “What do I like” and “What do I dislike”. The first question is currently “open” (i.e., selected for input by clicking on its numeral or heading, or merely by first arriving at this web page) so that possible values for the answer are shown. These values are “Casual user,” “Hobbyist/Enthusiast” and “Professional”.

FIG. 9A shows area 350 of FIG. 8 along with the index at 344 just after the shopper has selected “Hobbyist/Enthusiast” from the display of FIG. 8. Question 1 has closed and question 2 has opened so that the shopper may select an answer to the question “How will I use it?” Question 1 is now followed by the selected value for Question 1 so that the shopper is aware of the value set that they are creating as they go along. Also, the number of matching results is shown decreased from 106 in FIG. 8 to 39 in FIG. 9A. This is due to the narrowed category of reviews of digital SLR cameras that have “Hobbyist/Enthusiast” as the value for their user-type attribute.

FIG. 9B shows the result of having selected “Outdoors” for the value to question 2. In FIG. 9B, the number of matching results is now 35 since the category is narrowed to only those digital SLR cameras with item profiles that have “Hobbyist/Enthusiast” in the user-type attribute and that also have “Outdoors” in the uses attribute. Question 3 is now open which provides possible value selections for the “What do I like?” question.

FIG. 9C shows the result of a shopper selecting “Great Resolution” as the answer to question 3 in the display of FIG. 9B. Question 3 has changed to the text “Show me” followed by the selected value “Great Resolution” to put the attribute value in a form that is easier to understand. Question 4 has opened up but since it only has one possible value, that of “Not Good in Low Light,” that value is automatically selected as the value for question 4 and the possible selections box shows only “No refinements available.” The number of review results that match all four attribute values in FIG. 9C is shown as 28.

Thus, the items have been filtered by the shopper's selection of values for two affinity attributes and two additional filter conditions (i.e., “show me” and “don't show me”). The shopper can turn off filtering by any one of the four attributes by clicking the small “[x]” that follows the value for each attribute. Also, multiple values may be selected and would be listed sequentially following each attribute's question or indication, although this is not shown in the present example. In general, many other ways of obtaining attribute values and stating attributes that can be used are possible and any suitable approach can be used.

Other types of affinity attributes can be included in creating an item profile. Items with similar profiles can then be used to create assortments that a consumer may be interested in. For example, physical attributes of reviewers of an item can be included in the item's profile. Physical attributes such as weight, height, age, gender, body build, skin type, etc. can be used and will have different levels of relevance to different items. Experience or use-related attributes such as skill level, frequency of use, habits of use, specialization, etc. can be included. Environmental affects on use such as the weather, terrain, specific geographical locations, etc. can be used to characterize the item reviews and consumer needs or desires. Other preferences by either a reviewer or consumer can be used such as taste, smell, look and feel, etc.

Many types of specific affinity attributes can be created for different categories of items. For example, in sporting goods related products or services a skill level or proficiency can be defined as Beginner, Intermediate, Advanced, Enthusiast/Hobbyist, Expert/Professional, Guru, Competitive, Tournament, etc. A frequency of use can be Occasional, Daily, 1-2 times/week, 3-4 times/week, etc. Specialization can include Downhill skiing, Cross country skiing, Moguls, etc. Habits can include Weekend Warrior, Hard Core, For Fun, For Fitness, etc. Age ranges can be specified as Teen, Young at Heart, Mid-life Crisis, Golden Years, Over the Hill, etc. Size can be small build, medium build, large build, etc. Experience can include number of years, number of tournaments, place in finishes, awards, etc. Conditions can include indoor/outdoor, clay court, grass court, etc. Fitness level can be low, medium, high, etc.

Although embodiments of the invention have been discussed primarily with respect to specific arrangements, formats, protocols, etc. any other suitable design or approach can be used. For example, keywords can be created, presented and selected in any suitable manner. Keywords can be organized or presented as a list, menu, array, tree hierarchy or other assortment. Radio buttons, check boxes, selection highlighting, animating, drag and drop, or any other form of selection can be used. A keyword can include any representation of a word or words or other descriptive information that can be used to describe a product, service, brand name, company, person, event or other item of interest for a review. Use of the term “keyword” is not intended to limit the form of representation of information that can be used for an item review. For example, a keyword can include a symbol, image, audio, or other type of information.

Various ways to approve keywords are possible. For example, keywords need not require a literal match for correlation to detect keywords that are submitted or used by more than one user. Databases of, e.g., dictionary entries, thesaurus entries, synonyms, meaning similarities, etc., can be used so that words with similar meanings but different spellings can be matched as being essentially the same word or phrase. Language translation can be used. Other data such as usage statistics, web page data, newsgroup data, forum discussion data, foreign language data, marketing data, news, etc. can be used to determine the desirability of using a word as a new keyword.

Note that although specific controls and mechanisms for obtaining user input have been described that any manner of effectively obtaining user input can be used, as desired. For example, although mouse/pointer and keyboard input selection and entry have been described, any other user input device such as a trackball, digitizing tablet, voice recognition, stylus, keypad, data glove, etc., can be used. Any type of displayable or discrete controls can be used to accept user input. Any type or format of presentation of information is possible such as video, graphical, three-dimensional, virtual reality, audio, etc. can be used. Visual depictions such as symbols, graphs, charts, etc. can be used to show qualities or values.

The embodiments described herein are merely illustrative, and not restrictive, of the invention. For example, the network may include components such as routers, switches, servers and other components that are common in such networks. Further, these components may comprise software algorithms that implement connectivity functions between the network device and other devices.

Any suitable programming language can be used to implement the present invention including C, C++, Java, assembly language, etc. Different programming techniques can be employed such as procedural or object oriented. The routines can execute on a single processing device or multiple processors. Although the flowchart format demands that the steps be presented in a specific order, this order may be changed. Multiple steps can be performed at the same time. The flowchart sequence can be interrupted. The routines can operate in an operating system environment or as stand-alone routines occupying all, or a substantial part, of the system processing.

Steps can be performed by hardware or software, as desired. Note that steps can be added to, taken from or modified from the steps in the flowcharts presented in this specification without deviating from the scope of the invention. In general, the flowcharts are only used to indicate one possible sequence of basic operations to achieve a function.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

As used herein the various databases, application software or network tools may reside in one or more server computers and more particularly, in the memory of such server computers. As used herein, “memory” for purposes of embodiments of the present invention may be any medium that can contain, store, communicate, propagate, or transport the program for use by or in connection with the instruction execution system, apparatus, system or device. The memory can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment,” “an embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for providing item information, the method comprising:
accepting input from a first user to associate an affinity attribute value with an item;
displaying the affinity attribute value to a second user;
accepting a signal from a user input device operated by a second user to select the affinity attribute value; and
displaying information about the item.

2. The method of claim 1, wherein the item includes a product.

3. The method of claim 1, wherein the item includes a service.

4. The method of claim 1, wherein the affinity attribute value refers to how the item is used.

5. The method of claim 1, wherein the affinity attribute value indicates an experience level of a user of the item.

6. The method of claim 1, further comprising:
using a profile associated with the second user to select the item.

7. The method of claim 6, further comprising:
maintaining a profile associated with the item;
matching at least a portion of the second user's profile with at least a portion of the item's profile to select the item.

8. The method of claim 7, wherein the item's profile includes an experience level of an author of a review.

9. The method of claim 7, wherein the item's profile includes an indication of how an author of a review used the item.

10. The method of claim 9, wherein the item's profile includes at least one or more of the following: skill, frequency, habits, specialization.

11. The method of claim 7, wherein the item's profile includes at least one physical attribute of an author of a review.

12. The method of claim 11, wherein a physical attribute includes one or more of the following: weight, height, age, gender, build, skin type.

13. The method of claim 7, wherein the item's profile includes at least one environment condition.

14. An apparatus for providing item information, the apparatus comprising:
a processor;
a machine-readable storage medium including one or more instructions executable by the processor for:
accepting input from a first user to associate an affinity attribute value with an item;
displaying the affinity attribute value to a second user;
accepting a signal from a user input device operated by a second user to select the affinity attribute value; and
displaying information about the item.

15. The method of claim 14, wherein the item includes a product.

16. The method of claim 14, wherein the item includes a service.

17. The method of claim 14, wherein the affinity attribute value refers to how the item is used.

18. The method of claim 14, wherein the affinity attribute value indicates an experience level of a user of the item.

19. A machine-readable storage medium including one or more instructions executable by a processor for:
accepting input from a first user to associate an affinity attribute value with an item;
displaying the affinity attribute value to a second user;
accepting a signal from a user input device operated by a second user to select the affinity attribute value; and
displaying information about the item.
